(19) United States
(12) Patent Application Publication
(10) Pub. No.: US 2020/0174984 A1
(43) Pub. Date: Jun. 4, 2020

(54) DIVERSITY INDEX

(71) Applicants: Beibei Wang, Santa Clara, CA (US); Patrick Driscoll, Oakland, CA (US); Divyakumar Menghani, Sunnyvale, CA (US); Luxin Kang, Clyde Hill, WA (US)

(72) Inventors: Beibei Wang, Santa Clara, CA (US); Patrick Driscoll, Oakland, CA (US); Divyakumar Menghani, Sunnyvale, CA (US); Luxin Kang, Clyde Hill, WA (US)

(21) Appl. No.: 16/204,921

(22) Filed: Nov. 29, 2018

(51) Int. Cl. G06F 16/22; G06F 16/26

(52) U.S. Cl. CPC G06F 16/2237; G06F 16/26

(57) ABSTRACT

Disclosed are systems, methods, and non-transitory computer-readable media for generating a diversity index. A diversity index system determines distribution values indicating a distribution of a set of users among demographic groups defined by two or more diversity dimensions. The diversity index system generates a distribution vector based on the distribution values. The diversity index system determines, based on the distribution vector and a similarity matrix, a set of diversity index values forming a diversity index vector. The similarity index includes a set of similarity scores for the demographic groups. The diversity index system determines a diversity index score for the set of users based on the diversity index vector and the distribution vector. The diversity index score indicates a level of diversity amongst the users from the set of users.

### TECHNICAL FIELD

An embodiment of the present subject matter relates generally to data management and, more specifically, to generating a diversity index.

### BACKGROUND

Data indicating a diversity of a population has many applicable uses. For example, the diversity of a population may be used to gain insights into the population, which may be used to select content for the population or target the population in any way. The diversity of a population may also be used to determine underrepresented demographic groups, which in turn may be used to increase the diversity of the population. While diversity data has many applications, determining diversity is a complex issue involving multiple interacting demographic dimensions. Current solutions for determining diversity handle this issue poorly. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example system configuration, wherein electronic devices communicate via a network for purposes of exchanging content and other data.

FIG. 2. is a block diagram of the diversity index system, according to some example embodiments.

FIGS. 3A-3C show examples of similarity submatrices and a corresponding similarity matrix, according to some example embodiments.

FIG. 4 is a flowchart showing an example method of generating a diversity index for a population of users, according to certain example embodiments.

FIG. 5 is a flowchart showing an example method of generating a similarity matrix, according to certain example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for determining a diversity index for a population of users. The diversity index is a score or other value that indicates a level of diversity amongst a population of users based on a set of demographic dimensions. A demographic dimension is a criterion that defines demographic subsets of the users. For example, a demographic dimension may be a user's sex, which defines a first demographic subset including males and a second demographic subset including females. As another example, a demographic dimension may be a user's age, which defines multiple demographic subsets based on age (1, 2, 3, etc.) or age ranges (1-20, 21-40, etc.). Other examples of demographic dimensions include a user's ethnicity, religion, nationality, skills, physical abilities, job title, job level, experiences, education, etc.

A diversity index system determines the diversity index for a population of users using a generated similarity matrix and a distribution vector indicating a determined distribution of the users amongst the demographic subsets. The similarity index includes determined similarity scores for each demographic subset of users defined by the provided demographic dimensions. The distribution vector includes a set of distribution values that indicate the number and/or percentage of users from the population of users that fall within each of the demographic subsets of users defined by the provided demographic dimensions. The diversity index system determines the diversity index for the population of users based on the product of the similarity matrix multiplied by distribution vector. Calculation of the diversity index is described in greater detail below.

The similarity scores included in the similarity matrix are determined based on similarity scores determined for sub-matrices of the similarity matrix. Each sub-matrix is determined based on an individual demographic dimension, rather than the set of demographic dimensions used for the similarity matrix. For example, given a set of demographic dimensions including both age and gender, the diversity index system determines similarity scores for a first sub-matrix based on gender alone, and a second sub-matrix based on age alone. The demographic subsets and the similarity values included in each sub-matrix are then used to generate the similarity matrix based on both demographic dimensions. This allows the diversity index system to determine a diversity index for a population of users based on multiple diversity dimensions, which is an improvement over existing systems. This also allows weights to be applied to the individual diversity dimensions. For example, weights may be applied to the similarity scores in the sub-matrices prior to determining the similarity matrix.

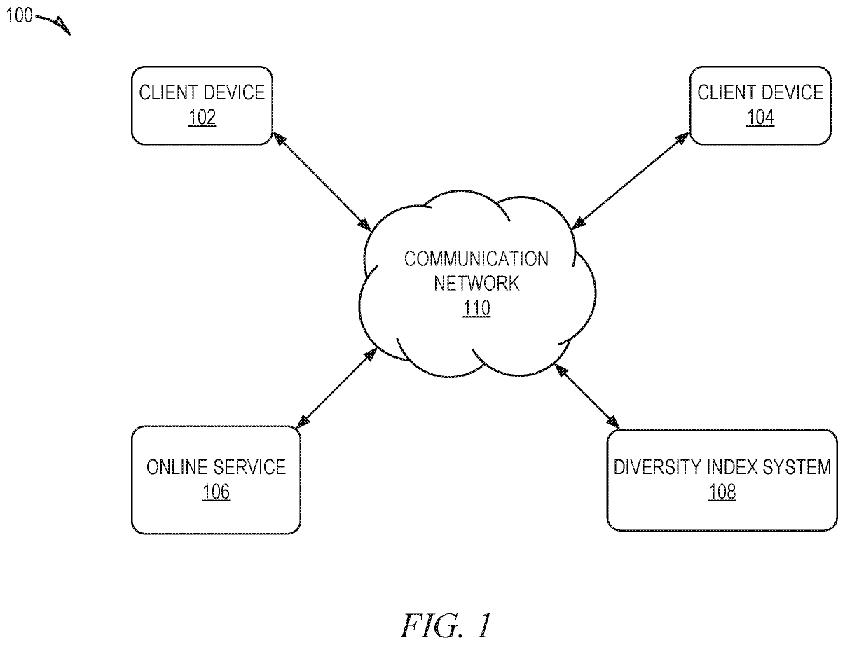

FIG. 1 shows an example system 100, wherein electronic devices communicate via a network for purposes of exchanging content and other data. As shown, multiple devices (i.e., client device 102, client device 104, online service 106, and diversity index system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

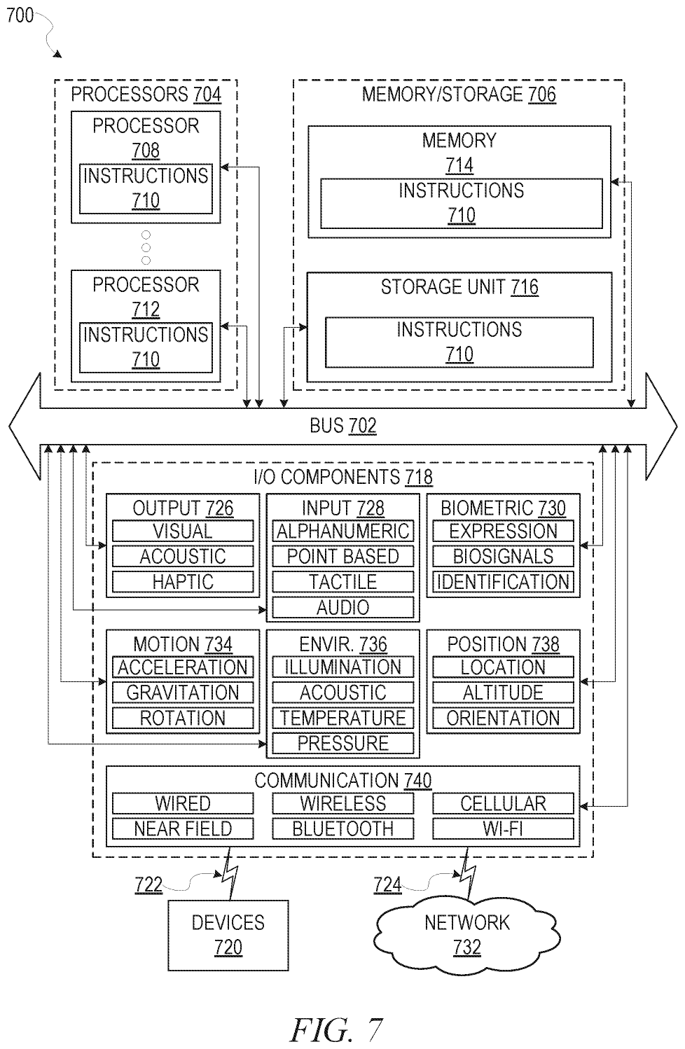

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the online service 106 to utilize the services provided by the online service 106. The online service 106 may provide any type of service, such as a social networking service, online retail service, messaging service, etc. For example, the online service 16 may provide a professional social networking service. Users communicate with and utilize the functionality of the online service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online service 106 may concurrently accept connections from and interact with any number of client devices 102, 104. The online service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online service 106 via a client-side application installed on the client devices 102 and 104. In some embodiments, the client-side application includes a component specific to the online service 106. For example, the component may be a stand-alone application, one or more application plug-ins, and/or a browser extension. However, the users may also interact with the online service 106 via a third-party application, such as a web browser, that resides on the client devices 102 and 104 and is configured to communicate with the online service 106. In either case, the client-side application presents a user interface (UI) for the user to interact with the online service 106. For example, the user interacts with the online service 106 via a client-side application integrated with the file system or via a webpage displayed using a web browser application.

The online service 106 is one or more computing devices configured to provide one or more services. For example, the online service 106 may be a messaging service that facilitates and manages communication sessions between various client devices 102, 104. As another example, the online service 106 may be a social networking service that allows users to share content with other members of the social networking service as well as view content posted by other members of the social networking service.

As part of its provided service, the online service 106 may provide analytical reports about populations of users. For example, an online service 106 such as a professional social network (e.g., LINKEDIN) may provide analytical reports describing the diversity of a select population of users/members of the professional social network based on a set of demographic dimensions. A demographic dimension is a criterion that defines demographic subsets of a population of users. For example, a demographic dimension may be a user's sex, which defines a first demographic subset including males and a second demographic subset including females. As another example, a demographic dimension may be a user's age, which defines multiple demographic subsets based on age (1, 2, 3, etc.) or age ranges (1-20, 21-40, etc.). Other examples of demographic dimensions include a user's ethnicity, religion, nationality, skills, physical abilities, job title, job level, experiences, education, etc.

The online service 106 utilizes the functionality of the diversity index system 108 to provide analytical reports describing the diversity of a select population of users. Although the diversity index system 108 and the online service 106 are shown as separate entities, this is just one embodiments and is not meant to be limiting. In some embodiments, the diversity index system 108 may be incorporated as part of the online service 106.

The diversity index system 108 is one or more computing device configured to determine a diversity index for a population of users. The diversity index is a score or other value that indicates a level of diversity amongst a population of users based on a set of demographic dimensions. The diversity index system 108 determines the diversity index using a generated similarity matrix and a distribution vector indicating a determined distribution of the users amongst the demographic subsets. The similarity index includes determined similarity scores for each demographic subset of users defined by the provided demographic dimensions. The distribution vector includes a set of distribution values that indicate the number and/or percentage of users from the population of users that fall within each of the demographic subsets of users defined by the provided demographic dimensions. The diversity index system 108 determines the diversity index for the population of users based on the product of the similarity matrix multiplied by distribution vector. Calculation of the diversity index is described in greater detail below.

The similarity scores included in the similarity matrix are determined based on similarity scores determined for sub-matrices of the similarity matrix. Each sub-matrix is based on an individual demographic dimension, rather than the set of demographic dimensions used for the similarity matrix. For example, given a set of demographic dimensions including both age and gender, the diversity index system 108 determines a first sub-matrix based on gender alone, and a second sub-matrix based on age alone. The demographic subsets and the similarity values included in each sub-matrix are then used to generate the similarity matrix based on both demographic dimensions. This allows the diversity index system 108 to determine a diversity index for a population of users based on multiple diversity dimensions, rather than being limited to a single diversity dimension. Although this example, only includes two demographic dimensions, this is just one example, and is not meant to be limiting. The diversity index system 108 may determine a diversity index for a population of users based on any number of diversity dimensions.

The online service 106 uses the similarity scores to generate analytical reports. For example, the analytical reports may indicate the diversity index for various populations of users, which provides a user with insights into the populations and how they compare to each other. The analytical reports may also include detailed breakdown data indicating the number and/or percentage of users in each demographic subgroup of the population of users, as well a recommendation on how to increase the overall diversity of the population of users. For example, the analytical report may indicate certain demographic subsets that are underrepresented in the population of users and suggest adding users from the underrepresented demographic subset.

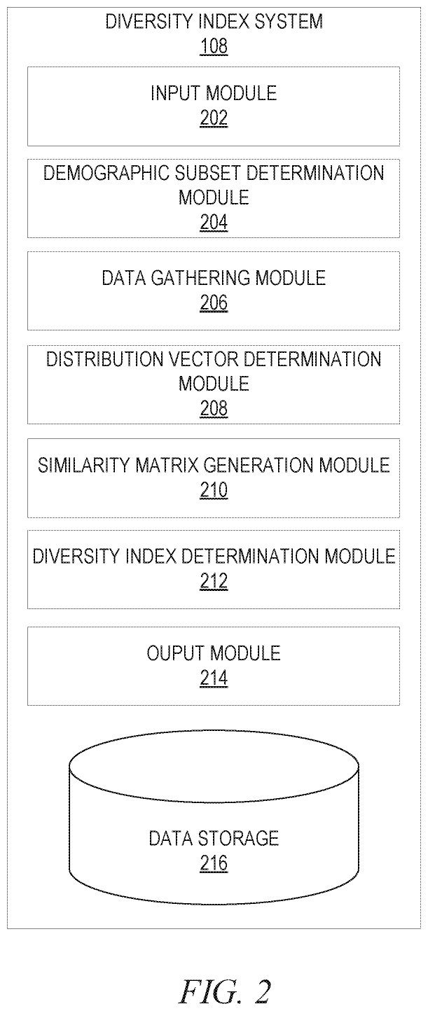

FIG. 2 is a block diagram of the diversity index system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the diversity index system 108 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed amongst computing devices that facilitate both the diversity index system 108 and the online service 106.

As shown, the diversity index system 108 includes an input module 202, a demographic subset determination module 204, a data gathering module 206, a distribution vector determination module 208, a similarity matrix generation module 210, a diversity index determination module 212, an output module 214, and a data storage 216.

The input module 202 receives input and data to generate a diversity index and/or an analytical report for a population of users. That is, the online service 106 provides an input, such as a request, to the diversity index system 108, which is received by the input module 202. The received input may include data used to generate the analytical report or diversity index. For example, the input may include data identifying one or more populations of users, diversity signals and/or demographic subsets for generating the diversity index. In some embodiments, the diversity index system 108 or the online service 106 provides a user interface that enables a user to request generation of a diversity index and/or analytical report. For example, the user interface may include user interface elements that allow a user to select a population of users, diversity dimensions and/or demographic subsets for generating the diversity index. The input module 202 provides the received input and/or data to the other modules of the diversity index system 108 to initiate generation of the requested diversity index and/or analytical reports.

The demographic subset determination module 204 determines demographic subsets of users based on the data received by the input module 202. The data received from the input module 202 may include data specifically identifying the demographic subsets, such as data defining age ranges, job titles, etc. In this type of situation, the demographic subset determination module 204 simply uses the received data to determine the demographic subsets. Alternatively, the data received by the input module 202 may not explicitly define the demographic subsets. For example, the data may include only the diversity signals. In this type of embodiment, the demographic subset determination module 204 determines the demographic subsets based on the received diversity signals. This may be accomplished by determining demographic subsets based on each individual diversity signal, and then using the resulting demographic subsets from the individual diversity signals to determine combined demographic subsets. For example, given the diversity signals of age and sex, the demographic subset determination module 204 may determine a set of demographic subsets for each diversity signal (e.g., age [20-30, 30-40], sex [M, F]), and use the determined sets of demographic subsets to determine a set of combined demographic subsets based on both diversity dimensions (e.g., age/sex [M20-30, M30-40, F20-30, F30-40]).

The data gathering module 206 gathers data used to generate the diversity index. For example, the data gathering module 206 uses the data provided by the input module 202 that identifies the population of users and/or the demographic subsets determined by the demographic subset determination module 204. The data gathering module 206 gathers the data from the data storage 216. The data storage 216 maintains profile data for multiple users. For example, the profile data may be associated with registered users of the online service 106. The profile data includes data describing the users, such as their age, location, nationality, employment history, educational history, skills, etc. The data gathering module 206 may gather all user profile data for an identified population of users or, alternatively, a subset of the profile data. For example, the data gathering module 206 may use the provided diversity dimensions to gather the profile data needed to properly determine which demographic subgroups each user is within.

The distribution vector determination module 208 determines a distribution vector based on the determined demographic subsets. A distribution vector includes a set of distribution values indicating the distribution of the users in the population amongst each demographic subset. That is, each distribution value in the distribution vector indicates the number and/or percentage of users from the population of users that fall within one of the demographic subsets of users. For example, a distribution vector may include the values [0.25, 0.5, 0.25, 0], indicating that 25% of the users are included in a first demographic subset, 50% of the users are included in a second demographic subset, 25% of the users are included in a third demographic subset, and 0% of the users are included in a fourth demographic subset.

The distribution vector determination module 208 determines the distribution values based on the profile data gathered by the data gathering module 206. That is, the distribution vector determination module 208 uses the profile data for each user in the population of users to determine the demographic subset to which the user belongs. For example, the distribution vector determination module 208 may gather profile data such as the user's age or sex to determine which demographic subset the user is within. The distribution vector determination module 208 determines the total number of users in each demographic subset and divides by the total number of users in the population of users to determine the percentage of the users that are within each demographic subset.

The similarity matrix generation module 210 generates a similarity matrix based on the demographic subsets determined by the demographic subset determination module 204. The generated similarity index includes determined similarity scores for each demographic subset of users. Each similarity score indicates the similarity between two users based on the demographic subset to which each user belongs.

To generate a similarity matrix, the similarity matrix generation module 210 initially determines similarity values for submatrices based on the individual diversity dimension, rather than the combination of the diversity dimensions. For example, to generate a similarity matrix based on the diversity dimensions age and sex, the similarity matrix generation module 210 initially determines similarity scores for a submatrix based on age, and another submatrix based on sex. The similarity matrix generation module 210 then uses the similarity scores for the submatrices to determine the similarity scores for the similarity matrix based on both diversity dimensions.

The similarity scores for each submatrix range from a minimum to maximum value, such as from 0 to 1, which indicate how similar two users are based on the demographic subset to which the users belong. A high similarity score (e.g., 1) indicates a high level of similarity between the two users, whereas a low similarity score (e.g., 0) indicates a low level of similarity between two users.

The similarity scores are based on the number of demographic subgroups defined by each diversity dimension. For example, the similarity scores for a submatrix with only two demographic subgroups will have only two similarity scores, one being the minimum (e.g., 0) for two users that are in different demographic subsets (e.g., male/female) and the other being the maximum (e.g., 1) for two users that are in the same demographic subset (e.g., male/female). As another example, the similarity scores for a submatrix with four demographic subgroups will have four similarity scores, ranging from the minimum to the maximum (e.g., 0, 0.33, 0.67, 1), based on how similar the two users are. For example, assuming demographic subgroups based on the age ranges 23-34, 35-44, 45-54, and 55-64, the similarity score for two users in different but similar demographic subgroups (e.g., 23-34 and 35-44) is relatively high (e.g., 0.67), whereas the similarity score for two users in different but not as similar demographic subgroups (e.g., 23-34 and 45-54) is lower (e.g., 0.33).

The similarity scores for the similarity matrix are determined based on the similarity scores for the submatrices. That is, the similarity scores for two users from each submatrix are used to determine the similarity score for the two users in the similarity matrix. For example, given a group of two users consisting of a Male 23-34 and another Male 35-44, the similarity score for the two users from the submatrix based on sex is 1, and the similarity score for the two users from the submatrix based on age is 0.67. The similarity matrix generation module 210 may determine the similarity score for the combined diversity dimensions based on the average of the similarity scores for the individual diversity dimensions. For example, given the above scenario, the similarity score for the two users is the average of 1 and 0.67, which is 0.83.

In some embodiments, the similarity matrix generation module 210 may apply weights to one or more of the diversity dimensions. For example, the similarity matrix generation module 210 may increase or decrease the similarity scores from any of the submatrices to provide additional or less weight to the corresponding diversity dimension. For example, to provide less weight to the sex of the users, the similarity matrix generation module 210 may reduce the similarity scores from the submatrix corresponding to sex prior to determining the similarity scores for the similarity matrix.

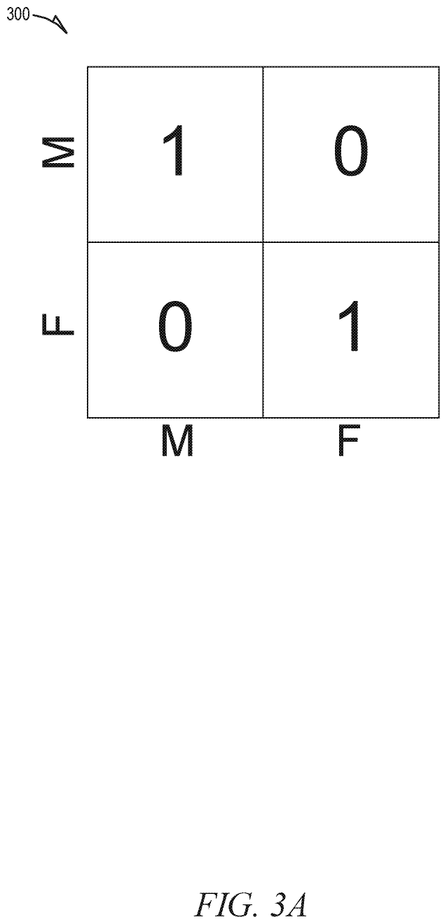

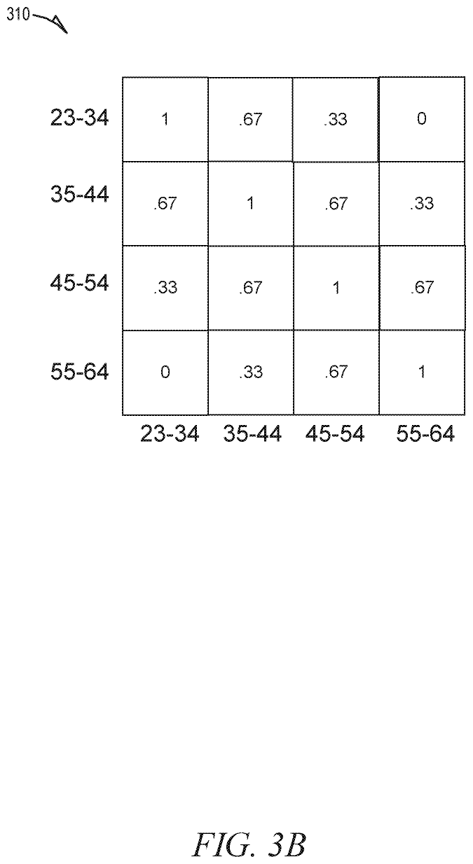

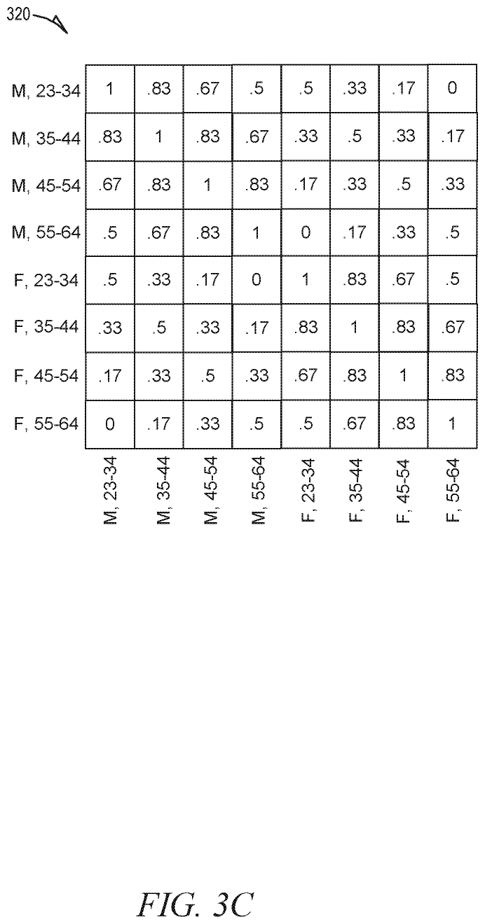

FIGS. 3A-3C show examples of similarity submatrices and a corresponding similarity matrix, according to some example embodiments. FIG. 3A shows a similarity submatrix 300 that is based on a single diversity dimension (e.g., sex of the users). Each axis of the similarity submatrix 300 identifies the demographic subsets (e.g., Male and Female) defined by the diversity dimension. The similarity submatrix 300 includes similarity scores ranging from 0 to 1 indicating how similar two users are based on the demographic subset to which the users belong. A similarity score of 1 indicates a high level of similarity between two users, whereas a similarity score of 0 indicates a low level of similarity between two users. Accordingly, the similarity score in the similarity submatrix 300 for two users that are both either female or male is 1, whereas the similarity score for two users that are a combination of female and male is 0. The similarity submatrix 300 includes two rows of similarity scores (i.e., [1, 0] and [0, 1]).

FIG. 3B shows another similarity submatrix 310 that is based on the diversity dimension of age. As shown, the similarity submatrix 310 includes similarity scores for four demographic subgroups based on age ranges (e.g., 23-34, 35-44, 45-54, and 55-64). The similarity scores in the similarity submatrix 310 indicate how similar two users are based on their demographic subset membership. For example, the similarity score between two users with the largest age gap (e.g., a user in age range 23-34 and another user in age range 55-64) is 0, indicating that the users are not very similar. As another example, the similarity score between two users with a smaller age gap (e.g., a user in the age range 23-34 and another user that is in the age rage 35-44) is 0.67, indicating that the users are fairly similar. As another example, two users in the same age range (e.g., both in the age range 23-34) have a similarity score of 1, indicating that the user are very similar.

The similarity submatrix 310 for age includes four rows of similarity scores (i.e., [1, 0.67, 0.33, 0], [0.67, 1, 0.67, 0.33], [0.33, 0.67, 1, 0.67] and [0, 0.33, 0.67, 1]). This is in contrast to the similarity submatrix 300 for sex which only had two rows of similarity scores.

FIG. 3C shows a similarity matrix 320 based on both sex and age. As shown, the similarity matrix 320 includes similarity scores for eight demographic subgroups based on both age ranges and sex (e.g., M 23-34, M 35-44, M 45-54, M 55-64, F 23-34, F 35-44, F 45-54, and F 55-64). Just as the similarity scores in similarity submatrices 300 and 310, the similarity scores in the similarity matrix 320 indicate how similar two users are based on their demographic subset membership.

The similarity scores in the similarity matrix 320 are based on the similarity scores in the similarity submatrices 300 and 310. For example, the similarity score in the similarity matrix 320 for a first user that is a M 23-34 and a second user that is a M 35-44 is based on the similarity scores for these two users from the similarity submatrices 300 and 310. The similarity score for two Males from similarity submatrix 300 is 1, and the similarity score for users ages 23-34 and 35-44 is 0.67. Accordingly, the similarity score in the similarity matrix 320 is 0.83, which is the average of the similarity scores from the similarity submatrices 300 and 310 (e.g., 1 and 0.67).

As another example, the similarity score in the similarity matrix 320 for a first user that is a M 23-34 and a second user that is a F 45-54 is based on the similarity scores for these two users from the similarity submatrices 300 and 310. The similarity score for a male and female from similarity submatrix 300 is 0, and the similarity score for users ages 23-34 and 45-54 is 0.33. Accordingly, the similarity score in the similarity matrix 320 is 0.17, which is the average of the similarity scores from the similarity submatrices 300 and 310 (e.g., 0 and 0.33).

Returning to the discussion of FIG. 2, the diversity index determination module 212 calculates a diversity index for a population of users based on the similarity matrix 320 generated by the similarity matrix generation module 210 and the distribution vector generated by the distribution vector determination module 208. The diversity index determination module 212 calculates the diversity index by multiplying the similarity matrix 320 by the diversity vector, which results in a diversity index vector. The diversity index determination module 212 then multiplies the diversity index vector by the diversity vector, resulting in a determined value, the inverse of which is the diversity index for the population of users. This is just one example of calculating the diversity index score and is not meant to be limiting. The diversity index determination module 212 may determine the diversity index using other methods as well, including using more or less steps than those described. For example, the diversity index determination module 212 may multiply the inverse of the determined value by a predetermined multiplier, such as 100, to result in the diversity index.

As an example, a population of 4 users is divided evenly into 4 demographic subgroups. Accordingly, the distribution vector for the population is [0.25, 0.25, 0.25, 0.25]. To determine the diversity index of the population of users, the diversity index determination module 212 first multiplies the distribution vector by the corresponding similarity matrix 320, resulting in the diversity index vector. To multiply the distribution vector by the corresponding similarity matrix 320, the diversity index determination module 212 determines a diversity index value for each row of the similarity index. Using the similarity matrix 320 shown in FIG. 3B as an example, the diversity index determination module 212 determines the diversity index value for the first row by calculating [(0.25*1)+(0.25*0.67)+(0.25*0.33)+(0.25*0)], resulting in the diversity index value of 0.50. The diversity index determination module 212 determines the diversity index value for the second row by calculating [(0.25*0.67)+(0.25*1)+(0.25*0.67)+(0.25*0.33)], resulting in the diversity index value of 0.67. The diversity index determination module 212 determines the diversity index value for the third row by calculating [(0.25*0.33)+(0.25*0.67)+(0.25*1)+(0.25*0.67)], resulting in the diversity index value of 0.67. The diversity index determination module 212 determines the diversity index value for the fourth row by calculating [(0.25*0.0)+(0.25*1)+(0.25*0.67)+(0.25*0.33)], resulting in the diversity index value of 0.50. Accordingly, the resulting diversity index vector consists of [0.50, 0.67, 0.67, 0.50].

The diversity index determination module 212 multiplies the diversity index vector by the distribution vector. Accordingly, the diversity index determination module 212 calculates [(0.25*0.50)+(0.25*0.67)+(0.25*0.67)+(0.25*0.50)], which results in the determined value of 0.583. The diversity index determination module 212 then inverts the determined value (e.g., 1/0.583) to result in the diversity index value of 1.72. In some embodiments, the diversity index determination module 212 may additionally multiply this value by a predetermined multiplier, such as 100, to result in a diversity index value of 172.

The output module 214 provides an output to the online service 106. The output may consist of simply the diversity index. As another example, the output may consist of an analytical report. For example, the analytical report may indicate the diversity index for various populations of users, which provides a user with insights into the populations and how they compare to each other. The analytical report may also include detailed breakdown data indicating the number and/or percentage of users in each demographic subgroup of the population of users, as well a recommendation on how to increase the overall diversity of the population of users. For example, the analytical report may indicate certain demographic subsets that are underrepresented in the population of users and suggest adding users from the underrepresented demographic subset.

These are just some examples of possible output and are not meant to be limiting. The output module 214 may provide any of a variety of forms of output that include and/or are derived from diversity indexes determined by the diversity index system 108.

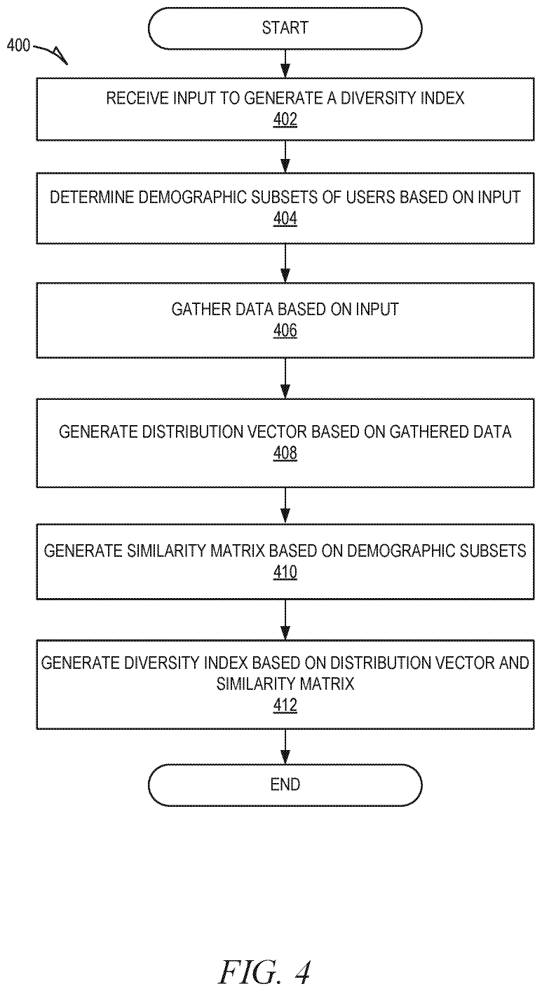

FIG. 4 is a flowchart showing an example method 400 of generating a diversity index for a population of users, according to certain example embodiments. The method 400 may be embodied in computer readable instructions for execution by one or more processors such that the operations of the method 400 may be performed in part or in whole by the diversity index system 108; accordingly, the method 400 is described below by way of example with reference thereto. However, it shall be appreciated that at least some of the operations of the method 400 may be deployed on various other hardware configurations and the method 400 is not intended to be limited to the diversity index system 108.

At operation 402, the input module 202 receives input to generate a diversity index. The input module 202 receives input and data to generate a diversity index and/or an analytical report for a population of users. That is, the online service 106 provides an input, such as a request, to the diversity index system 108, which is received by the input module 202. The received input may include data used to generate the analytical report or diversity index. For example, the input may include data identifying one or more populations of users, diversity signals and/or demographic subsets for generating the diversity index. In some embodiments, the diversity index system 108 or the online service 106 provides a user interface that enables a user to request generation of a diversity index and/or analytical report. For example, the user interface may include user interface elements that allows a user to select a population of users, diversity dimensions and/or demographic subsets for generating the diversity index. The input module 202 provides the received input and/or data to the other modules of the diversity index system 108 to initiate generation of the requested diversity index and/or analytical reports.

At operation 404, the demographic subset determination module 204 determines demographic subsets of users based on the input. The data received from the input module 202 may include data specifically identifying the demographic subsets, such as data defining age ranges, job titles, etc. In this type of situation, the demographic subset determination module 204 simply uses the received data to determine the demographic subsets. Alternatively, the data received by the input module 202 may not explicitly define the demographic subsets. For example, the data may include only the diversity signals. In this type of embodiment, the demographic subset determination module 204 determines the demographic subsets based on the received diversity signals. This may be accomplished by determining demographic subsets based on each individual diversity signal, and then using the resulting demographic subsets from the individual diversity signals to determine combined demographic subsets. For example, given the diversity signals of age and sex, the demographic subset determination module 204 may determine a set of demographic subsets for each diversity signal (e.g., age [20-30, 30-40], sex [M, F]), and use the determined sets of demographic subsets to determine a set of combined demographic subsets based on both diversity dimensions (e.g., age/sex [M20-30, M30-40, F20-30, F30-40]).

At operation 406, the data gathering module 206 gathers data based on the input. For example, the data gathering module 206 uses the data provided by the input module 202 that identifies the population or users and/or the demographic subsets determined by the demographic subset determination module 204. The data gathering module 206 gathers the data from the data storage 216. The data storage 216 maintains profile data for multiple users. For example, the profile data may be associated with registered users of the online service 106. The profile data includes data describing the users, such as their age, location, nationality, employment history, educational history, skills, etc. The data gathering module 206 may gather all user profile data for an identified population of users or, alternatively, a subset of the profile data. For example, the data gathering module 206 may use the provided diversity dimensions to gather the profile data needed to properly determine which demographic subgroups each user is within.

At operation 408, the distribution vector determination module 208 generates a distribution vector based on the gathered data. A distribution vector included a set of distribution values indicating the distribution of the users in the population amongst each demographic subset. That is, each distribution value in the distribution vector indicates the number and/or percentage of users from the population of users that fall within one of the demographic subsets of users. For example, a distribution vector may include the values [0.25, 0.5, 0.25, 0], indicating that 25% of the users are included in a first demographic subset, 50% of the users are included in a second demographic subset, 25% of the users are included in a third demographic subset, and 0% of the users are included in a fourth demographic subset.

The distribution vector determination module 208 determines the distribution values based on the profile data gathered by the data gathering module 206. That is, the distribution vector determination module 208 uses the profile data for each user in the population of users to determine the demographic subset to which the user belongs. For example, the distribution vector determination module 208 may gather profile data such as the user's age or sex to determine which demographic subset the user is within. The distribution vector determination module 208 determines the total number of users in each demographic subset and divides by the total number of users in the population of users to determine the percentage of the users that are within each demographic subset.

At operation 410, the similarity matrix generation module 210 generates a similarity matrix 320 based on the demographic subsets. The generated similarity matrix 320 includes determined similarity scores for each demographic subset of users. Each similarity score indicates the similarity between two users based on the demographic subset to which each user belongs.

To generate a similarity matrix 320, the similarity matrix generation module 210 initially determines similarity values for submatrices based on the individual diversity dimension, rather than the combination of the diversity dimensions. For example, to generate a similarity matrix 320 based on the diversity dimensions age and sex, the similarity matrix generation module 210 initially determines similarity scores for a submatrix based on age, and another submatrix based on sex. The similarity matrix generation module 210 then uses the similarity scores for the submatrices to determine the similarity scores for the similarity matrix 320 based on both diversity dimensions.

At operation 412, the diversity index determination module 212 generates a diversity index based on the distribution vector and the similarity matrix 320. The diversity index determination module 212 calculates the diversity index by multiplying the similarity matrix 320 by the diversity vector, which results in a diversity index vector. The diversity index determination module 212 then multiplies the diversity index vector by the diversity vector, resulting in a determined value, the inverse of which is the diversity index for the population of users. This is just one example of calculating the diversity index score and is not meant to be limiting. The diversity index determination module 212 may determine the diversity index using other methods as well, including using more or less steps than those described. For example, the diversity index determination module 212 may multiply the inverse of the determined value by a predetermined multiplier, such as 100, to result in the diversity index.

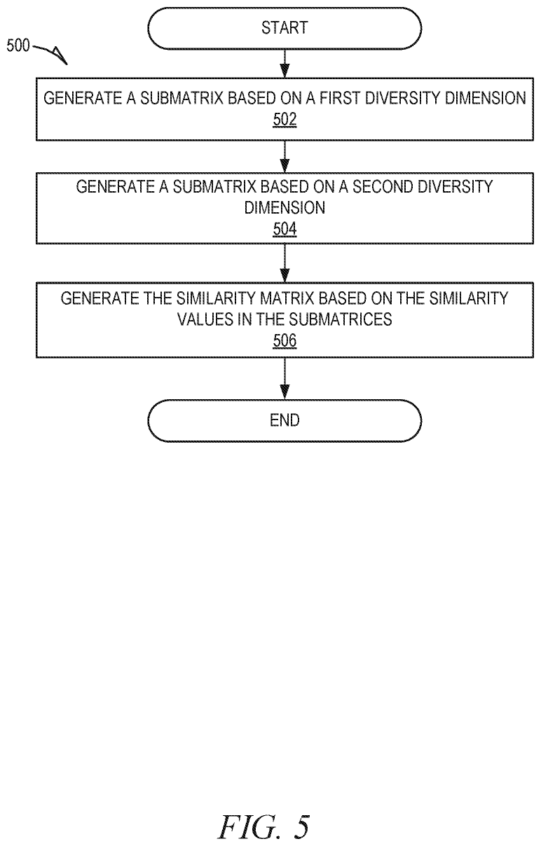

FIG. 5 is a flowchart showing an example method 500 of generating a similarity matrix 320, according to certain example embodiments. The method 500 may be embodied in computer readable instructions for execution by one or more processors such that the operations of the method 500 may be performed in part or in whole by the diversity index system 108; accordingly, the method 500 is described below by way of example with reference thereto. However, it shall be appreciated that at least some of the operations of the method 500 may be deployed on various other hardware configurations and the method 500 is not intended to be limited to the diversity index system 108.

At operation 502, the similarity matrix generation module 210 generates a submatrix based on a first diversity dimension. For example, the first diversity dimension may be a single diversity dimension such as age or sex. The similarity matrix generation module 210 determines similarity scores for the submatrix based on the number of demographic subgroups defined by the first diversity dimension. The similarity scores for the submatrix range from a minimum value to a maximum value, such as from 0 to 1, which indicate how similar two users are based on the demographic subset to which the users belong. A high similarity score (e.g., 1) indicates a high level of similarity between the two users, whereas a low similarity score (e.g., 0) indicates a low level of similarity between two users.

The similarity scores are based on the number of demographic subgroups defined by the first diversity dimension. For example, if there are only two demographic subgroups, the diversity index will have only two similarity scores, one similarity score being the minimum (e.g., 0) indicating two users that are in different demographic subsets (e.g., male/female) and the other similarity score being the maximum (e.g., 1) for two users that are in the same demographic subset (e.g., male/female). As another example, the similarity scores for four demographic subgroups will have four similarity scores, ranging from the minimum to the maximum (e.g., 0, 0.33, 0.67, 1), based on how similar the two users are. For example, assuming demographic subgroups based on the age ranges 23-34, 35-44, 45-54, and 55-64, the similarity score for two users in different but similar demographic subgroups (e.g., 23-34 and 35-44) is relatively high (e.g., 0.67), whereas the similarity score for two users in different but not as similar demographic subgroups (e.g., 23-34 and 45-54) is lower (e.g., 0.33).

At operation 504, the similarity matrix generation module 210 generates a submatrix based on a second diversity dimension. The second diversity dimension is different than the first diversity dimension. For example, the first diversity dimension may be age and the second diversity dimension may be sex.

At operation 506, the similarity matrix generation module 210 generates the similarity matrix 320 based on the similarity values in the submatrices. That is, the similarity matrix generation module 210 generates the similarity matrix 320 based on the similarity values in the submatrix generated based on the first diversity dimension and the similarity values in the submatrix generated based on the second diversity dimension.

The similarity scores for the similarity matrix 320 are determined based on the similarity scores for the submatrices. That is, the similarity scores for two users from each submatrix are used to determine the similarity score for the two users in the similarity matrix 320. For example, given a group of two users consisting of a Male 23-34 and another Male 35-44, the similarity score for the two users from the submatrix based on sex is 1, and the similarity score for the two users from the submatrix based on age is 0.67. The similarity matrix generation module 210 may determine the similarity score for the combined diversity dimensions based on the average of the similarity scores for the individual diversity dimensions. For example, given the above scenario, the similarity score for the two users is the average of 1 and 0.67, which is 0.83.

In some embodiments, the similarity matrix generation module 210 may apply weights to one or more of the diversity dimensions. For example, the similarity matrix generation module 210 may increase or decrease the similarity scores from any of the submatrices to provide additional or less weight to the corresponding diversity dimension. For example, to provide less weight to the sex of the users, the similarity matrix generation module 210 may reduce the similarity scores from the submatrix corresponding to sex prior to determining the similarity scores for the similarity matrix 320.

Software Architecture

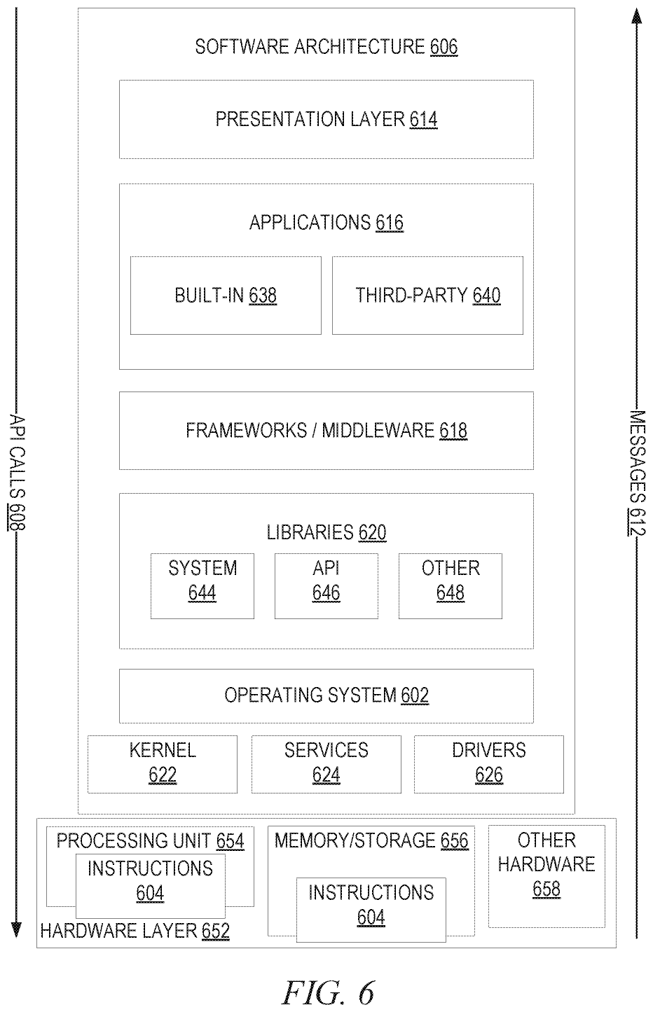

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke application programming interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor 704) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 704 may further be a multi-core processor having two or more independent processors 704 (sometimes referred to as “cores”) that may execute instructions 710 contemporaneously.

What is claimed is:

1. A method comprising:
determining, based on data describing a set of users, a first distribution value indicating a distribution of users from the set of users that are within a first demographic group, the first group defined based on a set of two or more diversity dimensions;
determining, based on the data describing the set of users, a second distribution value indicating a distribution of the users from the set of users that are within a second demographic group, the second group defined based on the set of two or more diversity dimensions, wherein the users that are within the first demographic group are not in the second demographic group, and the users that are within the second demographic group are not in the first demographic group;
generating a distribution vector based on at least the first distribution value and the second distribution value;
determining, based on the distribution vector and a similarity matrix, a set of diversity index values forming a diversity index vector, the similarity index including a set of similarity scores for at least the first demographic group and the second demographic group; and
determining a diversity index score for the set of users based on the diversity index vector and the distribution vector, the diversity index score indicating a level of diversity amongst the users from the set of users.

2. The method of claim 1, further comprising:
determining, for a first diversity dimension from the set of two or more diversity dimensions, a first set of demographic groups;
generating, based on the first set of demographic groups, a first similarity sub-matrix, the first similarity sub-matrix including similarity scores for each demographic group from the first set of demographic groups;
determining, for a second diversity dimension from the set of two or more diversity dimensions, a second set of demographic groups;
generating, based on the second set of demographic groups, a second similarity sub-matrix, the second similarity sub-matrix including similarity scores for each demographic group from the second set of demographic groups;
determining, based on the first set of demographic groups and the second set of demographic groups, a third set of demographic groups, the third set of demographic groups including combinations of the first set of demographic groups and the second set of demographic groups; and
generating the similarity matrix based on the first similarity sub-matrix and the second similarity sub-matrix, the similarity matrix including similarity scores for each demographic group from the third set of demographic groups.

3. The method of claim 2, wherein generating the similarity matrix comprises:
determining, based on the first similarity sub-matrix, a similarity score corresponding to a first demographic group from the first similarity sub-matrix;
determining, based on the second similarity sub-matrix, a similarity score corresponding to a second demographic group from the second similarity sub-matrix;
determining, based on the similarity score corresponding to the first demographic group from the first similarity sub-matrix and the similarity score corresponding to the second demographic group from the second similarity sub-matrix, a similarity score for a third demographic group from the similarity matrix, the third demographic group representing a combination of the first demographic group from the first similarity sub-matrix and the second demographic group from the second similarity sub-matrix.

4. The method of claim 3, wherein determining the similarity score for the third demographic group from the similarity matrix comprises:
applying a first weight value to the similarity score corresponding to the first demographic group from the first similarity sub-matrix, yielding a first weighted value;
applying a second weight value to the similarity score corresponding to the second demographic group from the second similarity sub-matrix, yielding a second weighted value; and
determining the similarity score for the third demographic group from the similarity matrix based on the first weighted value and the second weighted value.

5. The method of claim 1, wherein determining the diversity index score for the set of users comprises:
multiplying the diversity index vector by the distribution vector, yielding a determined value; and
determining an inverse of the determined value, yielding a raw diversity index score for the set of users.

6. The method of claim 5, further comprising:
multiplying the raw diversity index score by a predetermined multiplier, yielding the diversity index score for the set of users.

7. The method of claim 1, further comprising:
generating a report comparing the diversity index score for the set of users to a second diversity index score for a second set of users; and
causing presentation of the report within a user interface on a display of a client device.

8. A system comprising:
one or more computer processors; and
one or more computer-readable mediums storing instructions that, when executed by the one or more computer processors, cause the system to perform operations comprising:
determining, based on data describing a set of users, a first distribution value indicating a distribution of users from the set of users that are within a first demographic group, the first group defined based on a set of two or more diversity dimensions;
determining, based on the data describing the set of users, a second distribution value indicating a distribution of the users from the set of users that are within a second demographic group, the second group defined based on the set of two or more diversity dimensions, wherein the users that are within the first demographic group are not in the second demographic group, and the users that are within the second demographic group are not in the first demographic group;
generating a distribution vector based on at least the first distribution value and the second distribution value;
determining, based on the distribution vector and a similarity matrix, a set of diversity index values forming a diversity index vector, the similarity index including a set of similarity scores for at least the first demographic group and the second demographic group; and
determining a diversity index score for the set of users based on the diversity index vector and the distribution vector, the diversity index score indicating a level of diversity amongst the users from the set of users.

9. The system of claim 8, the operations further comprising:
determining, for a first diversity dimension from the set of two or more diversity dimensions, a first set of demographic groups;
generating, based on the first set of demographic groups, a first similarity sub-matrix, the first similarity sub-matrix including similarity scores for each demographic group from the first set of demographic groups;
determining, for a second diversity dimension from the set of two or more diversity dimensions, a second set of demographic groups;
generating, based on the second set of demographic groups, a second similarity sub-matrix, the second similarity sub-matrix including similarity scores for each demographic group from the second set of demographic groups;
determining, based on the first set of demographic groups and the second set of demographic groups, a third set of demographic groups, the third set of demographic groups including combinations of the first set of demographic groups and the second set of demographic groups; and
generating the similarity matrix based on the first similarity sub-matrix and the second similarity sub-matrix, the similarity matrix including similarity scores for each demographic group from the third set of demographic groups.

10. The system of claim 9, wherein generating the similarity matrix comprises:
determining, based on the first similarity sub-matrix, a similarity score corresponding to a first demographic group from the first similarity sub-matrix;
determining, based on the second similarity sub-matrix, a similarity score corresponding to a second demographic group from the second similarity sub-matrix;
determining, based on the similarity score corresponding to the first demographic group from the first similarity sub-matrix and the similarity score corresponding to the second demographic group from the second similarity sub-matrix, a similarity score for a third demographic group from the similarity matrix, the third demographic group representing a combination of the first demographic group from the first similarity sub-matrix and the second demographic group from the second similarity sub-matrix.

11. The system of claim 10, wherein determining the similarity score for the third demographic group from the similarity matrix comprises:
applying a first weight value to the similarity score corresponding to the first demographic group from the first similarity sub-matrix, yielding a first weighted value;
applying a second weight value to the similarity score corresponding to the second demographic group from the second similarity sub-matrix, yielding a second weighted value; and
determining the similarity score for the third demographic group from the similarity matrix based on the first weighted value and the second weighted value.

12. The system of claim 8, wherein determining the diversity index score for the set of users comprises:
multiplying the diversity index vector by the distribution vector, yielding a determined value; and
determining an inverse of the determined value, yielding a raw diversity index score for the set of users.

13. The system of claim 12, the operations further comprising:
multiplying the raw diversity index score by a predetermined multiplier, yielding the diversity index score for the set of users.

14. The system of claim 8, the operations further comprising:
generating a report comparing the diversity index score for the set of users to a second diversity index score for a second set of users; and
causing presentation of the report within a user interface on a display of a client device.

15. A non-transitory computer-readable medium storing instructions that, when executed by the one or more computer processors of a computing system, cause the computing system to perform operations comprising:
determining, based on data describing a set of users, a first distribution value indicating a distribution of users from the set of users that are within a first demographic group, the first group defined based on a set of two or more diversity dimensions;
determining, based on the data describing the set of users, a second distribution value indicating a distribution of the users from the set of users that are within a second demographic group, the second group defined based on the set of two or more diversity dimensions, wherein the users that are within the first demographic group are not in the second demographic group, and the users that are within the second demographic group are not in the first demographic group;
generating a distribution vector based on at least the first distribution value and the second distribution value;
determining, based on the distribution vector and a similarity matrix, a set of diversity index values forming a diversity index vector, the similarity index including a set of similarity scores for at least the first demographic group and the second demographic group; and
determining a diversity index score for the set of users based on the diversity index vector and the distribution vector, the diversity index score indicating a level of diversity amongst the users from the set of users.

16. The non-transitory computer-readable medium of claim 15, the operations further comprising:
determining, for a first diversity dimension from the set of two or more diversity dimensions, a first set of demographic groups;
generating, based on the first set of demographic groups, a first similarity sub-matrix, the first similarity sub-matrix including similarity scores for each demographic group from the first set of demographic groups;
determining, for a second diversity dimension from the set of two or more diversity dimensions, a second set of demographic groups;
generating, based on the second set of demographic groups, a second similarity sub-matrix, the second similarity sub-matrix including similarity scores for each demographic group from the second set of demographic groups;
determining, based on the first set of demographic groups and the second set of demographic groups, a third set of demographic groups, the third set of demographic groups including combinations of the first set of demographic groups and the second set of demographic groups; and
generating the similarity matrix based on the first similarity sub-matrix and the second similarity sub-matrix, the similarity matrix including similarity scores for each demographic group from the third set of demographic groups.

17. The non-transitory computer-readable medium of claim 16, wherein generating the similarity matrix comprises:
determining, based on the first similarity sub-matrix, a similarity score corresponding to a first demographic group from the first similarity sub-matrix;
determining, based on the second similarity sub-matrix, a similarity score corresponding to a second demographic group from the second similarity sub-matrix;
determining, based on the similarity score corresponding to the first demographic group from the first similarity sub-matrix and the similarity score corresponding to the second demographic group from the second similarity sub-matrix, a similarity score for a third demographic group from the similarity matrix, the third demographic group representing a combination of the first demographic group from the first similarity sub-matrix and the second demographic group from the second similarity sub-matrix.

18. The non-transitory computer-readable medium of claim 17, wherein determining the similarity score for the third demographic group from the similarity matrix comprises:
applying a first weight value to the similarity score corresponding to the first demographic group from the first similarity sub-matrix, yielding a first weighted value;
applying a second weight value to the similarity score corresponding to the second demographic group from the second similarity sub-matrix, yielding a second weighted value; and
determining the similarity score for the third demographic group from the similarity matrix based on the first weighted value and the second weighted value.

19. The non-transitory computer-readable medium of claim 15, wherein determining the diversity index score for the set of users comprises:
multiplying the diversity index vector by the distribution vector, yielding a determined value;
determining an inverse of the determined value, yielding a raw diversity index score for the set of users; and
multiplying the raw diversity index score by a predetermined multiplier, yielding the diversity index score for the set of users.

20. The non-transitory computer-readable medium of claim 15, the operations further comprising:
generating a report comparing the diversity index score for the set of users to a second diversity index score for a second set of users; and
causing presentation of the report within a user interface on a display of a client device.
